(19) United States
(12) Patent Application Publication
(10) Pub. No.: US 2016/0115293 A1
(43) Pub. Date: Apr. 28, 2016

(54) GRAPHENE DISPERSIONS

(71) Applicants: VORBECK MATERIALS CORPORATION, Jessup, MD (US); THE TRUSTEES OF PRINCETON UNIVERSITY, Princeton, NJ (US); KORDSA GLOBAL, Levent, Besiktas, (TR)

(72) Inventors: Ilhan AKSAY, Princeton, NJ (US); Sibel KORKUT, Princeton, NJ (US); Jeffrey KACZMARCZYK, Newark, DE (US); Sezen GURDAG, Kocaeli (TR); Deniz KORKMAZ, Kocaeli (TR)

(73) Assignees: VORBECK MATERIALS CORPORATION, Jessup, MD (US); THE TRUSTEES OF PRINCETON UNIVERSITY, Princeton, NJ (US); KORDSA GLOBAL, Levent, Besiktas Istanbul (TR)

(21) Appl. No.: 14/890,856

(22) PCT Filed: May 14, 2014
(86) PCT No.: PCT/US14/37982

§ 371 Date: Nov. 12, 2015

Related U.S. Application Data
(60) Provisional application No. 61/823,131, filed on May 14, 2013.

(51) Int. Cl. C08K 3/04; C09D 7/12

(52) U.S. Cl. CPC C08K 3/04; C09D 7/1216

(57) ABSTRACT

Method of making a composition comprising graphene sheets and at least one solvent, comprising dispersing a mixture of graphene sheets and graphite particles in a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, and flocculating the dispersion of graphene sheets. The flocculated dispersion can be added to a polymer matrix to make a composite. The composite can be formed into articles.

### FIELD OF THE INVENTION

The present invention relates to dispersions comprising graphene sheets and solvents.

### BACKGROUND

Graphene is finding increasing uses in a wide range of areas. In powder form graphene can be difficult to handle, and it would in many applications be desirable to use a dispersion of graphene in a solvent. In some cases (including in some cases the products of certain procedures for making bulk graphene), larger, hard to disperse particles (hard aggregates) may be present together with graphene. Such particles can be a disadvantage in certain applications. It would be desirable to obtain graphene dispersions that have at most small amounts of such particles.

### SUMMARY OF THE INVENTION

Disclosed and claimed herein is a method of making a composition comprising graphene sheets and at least one solvent, comprising dispersing a mixture of graphene sheets and graphite particles in a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, and flocculating the dispersion of graphene sheets. Further disclosed and claimed is a method of making a polymer composite material, comprising dispersing a mixture of graphene sheets and graphite particles into a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, separating the graphene sheets and the graphite particles to obtain a dispersion of graphene sheets that contains no more than about 25% of particles having more than about 50 layers, based on the total number of graphite particles and graphene sheets; flocculating the dispersion of graphene sheets; and adding the flocculated dispersion to a polymer matrix. Further disclosed and claimed is a method of making a polymeric article, comprising forming a polymer composite material by dispersing a mixture of graphene sheets and graphite particles into a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, separating the graphene sheets and the graphite particles to obtain a dispersion of graphene sheets that contains no more than about 25% of particles having more than about 50 layers, based on the total number of graphite particles and graphene sheets; flocculating the dispersion of graphene sheets; adding the flocculated dispersion to a polymer matrix to form the polymer composite material; and forming the polymer composite material into an article.

### BRIEF DESCRIPTION OF THE DRAWINGS

FIG. 1a is a plot showing the effect of graphene sheets concentration and hard aggregates on the elongation at failure of PET fibers.

FIG. 1b is a plot showing the effect of graphene sheets concentration and hard aggregates on the standard deviation of the elongation at failure of PET fibers

FIG. 2 is a plot showing the effect of graphene sheets on the crystallinity of spun PET fiber.

### DETAILED DESCRIPTION OF THE INVENTION

The compositions are made by dispersing graphene sheets in a solvent. The dispersed graphene sheets are separated from any hard aggregates that are present, while remaining dispersed in the solvent. The dispersion of graphene sheets is then treated with a flocculating agent to form the compositions. Upon treatment with the flocculating agent the graphene sheets can form loose aggregates that can be readily redispersed. The flocculated dispersion can be further concentrated. It can be used in other applications, such as to make composites (such as polymer composites), electrodes, inks and coatings, etc.

Graphite is made up of many layers of graphene, which are one-atom thick sheets of carbon atoms arranged in a hexagonal lattice. As used herein, the term “graphene sheets” refers to materials having one or more layers of graphene that have a surface area of from about 100 to about 2630 m²/g. In some cases, the graphene sheets primarily, almost completely, or completely comprise fully exfoliated single sheets of graphene, while in other embodiments, at least a portion of the graphene sheets can comprise partially exfoliated graphite. The graphene sheets can comprise mixtures of fully and partially exfoliated graphite sheets. Graphene sheets are distinct from carbon nanotubes. Graphene sheets can have a “platy” (e.g. two-dimensional) structure and do not have the needle-like form of carbon nanotubes. The two longest dimensions of the graphene sheets can each be at least about 10 times greater, or at least about 50 times greater, or at least about 100 times greater, or at least about 1000 times greater, or at least about 5000 times greater, or at least about 10,000 times greater than the shortest dimension (i.e. thickness) of the sheets. Graphene sheets are distinct from expanded, exfoliated, vermicular, etc. graphite, which has a layered or stacked structure in which the layers are not separated from each other. The graphene sheets do not need to be entirely made up of carbon, but can have heteroatoms incorporated into the lattice or as part of functional groups attached to the lattice. The lattice need not be a perfect hexagonal lattice and may contain defects (including five- and seven-membered rings).

Graphene sheets may be made using any suitable method. For example, they may be obtained from graphite, graphite oxide, expandable graphite, expanded graphite, etc. They may be obtained by the physical exfoliation of graphite, by for example, peeling, grinding, milling, graphene sheets. They made be made by sonication of precursors such as graphite. They may be made by opening carbon nanotubes. They may be made from inorganic precursors, such as silicon carbide. They may be made by chemical vapor deposition (such as by reacting a methane and hydrogen on a metal surface). They may be made by epitaxial growth on substrates such as silicon carbide and metal substrates and by growth from metal-carbon melts. They made by made They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made from small molecule precursors such as carbon dioxide, alcohols (such as ethanol, methanol, etc.), alkoxides (such as ethoxides, methoxides, etc., including sodium, potassium, and other alkoxides). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc. Exfoliation processes may be thermal, and include exfoliation by rapid heating, using microwaves, furnaces, hot baths, etc.

Graphene sheets can be made from graphite oxide (also known as graphitic acid or graphene oxide). Graphite can be treated with oxidizing and/or intercalating agents and exfoliated. Graphite can also be treated with intercalating agents and electrochemically oxidized and exfoliated. Graphene sheets can be formed by ultrasonically exfoliating suspensions of graphite and/or graphite oxide in a liquid (which can contain surfactants and/or intercalants). Exfoliated graphite oxide dispersions or suspensions can be subsequently reduced to graphene sheets. Graphene sheets can also be formed by mechanical treatment (such as grinding or milling) to exfoliate graphite or graphite oxide (which would subsequently be reduced to graphene sheets).

Reduction of graphite oxide to graphene can be by means of chemical reduction and can be carried out on graphite oxide in a dry form, in a dispersion, etc. Examples of useful chemical reducing agents include, but are not limited to, hydrazines (such as hydrazine, N,N-dimethylhydrazine, etc.), sodium borohydride, citric acid, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets.

Graphite oxide can be produced by any method known in the art, such as by a process that involves oxidation of graphite using one or more chemical oxidizing agents and, optionally, intercalating agents such as sulfuric acid. Examples of oxidizing agents include nitric acid, nitrates (such as sodium and potassium nitrates), perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, bisulfites, etc. Preferred oxidants include KClO₄⁻; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite can also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets can display little or no signature corresponding to graphite or graphite oxide in their X-ray diffraction pattern.

The thermal exfoliation can be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating can be done using a flash lamp or with microwaves. During heating, the graphite oxide can be contained in an essentially constant location in single batch reaction vessel, or can be transported through one or more vessels during the reaction in a continuous or batch mode. Heating can be done using any suitable means, including the use of furnaces and infrared heaters.

Examples of temperatures at which the thermal exfoliation and/or reduction of graphite oxide can be carried out are at least about 150° C., at least about 200° C., at least about 300° C., at least about 400° C., at least about 450° C., at least about 500° C., at least about 600° C., at least about 700° C., at least about 750° C., at least about 800° C., at least about 850° C., at least about 900° C., at least about 950° C., at least about 1000° C., at least about 1100° C., at least about 1500° C., at least about 2000° C., and at least about 2500° C. Preferred ranges include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature can vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets can be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used can be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature can vary within these ranges.

The heating can be done under a variety of conditions, including in an inert atmosphere (such as argon or nitrogen) or a reducing atmosphere, such as hydrogen (including hydrogen diluted in an inert gas such as argon or nitrogen), or under vacuum. The heating can be done in any appropriate vessel, such as a fused silica or a mineral or ceramic vessel or a metal vessel. The materials being heated including any starting materials and any products or intermediates) can be contained in an essentially constant location in single batch reaction vessel, or can be transported through one or more vessels during the reaction in a continuous or batch reaction. Heating can be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area can be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets can have a bulk density of from about 0.01 to at least about 200 kg/m³. The bulk density includes all values and subvalues therebetween, especially including 0.05, 0.1, 0.5, 1, 5, 10, 15, 20, 25, 30, 35, 50, 75, 100, 125, 150, and 175 kg/m³.

The graphene sheets can be functionalized with, for example, oxygen-containing functional groups (including, for example, hydroxyl, carboxyl, and epoxy groups) and typically have an overall carbon to oxygen molar ratio (CIO ratio), as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets can contain atomic scale kinks. These kinks can be caused by the presence of lattice defects in, or by chemical functionalization of the two-dimensional hexagonal lattice structure of the graphite basal plane.

By “hard aggregates” is meant particles derived from graphite that are made up of more than about 10 layers of graphene. In some cases, they may be made of up of more than about 10, or more than about 15, or more than about 20, or more than about 25, or more than about 30, or more than about 50, or more than about 75, or more than about 100 layers of layers of graphene, or more than about 200, or more than about 500, or more than about 1000, or more than about 5000 layers of graphene.

The composition has no more than about 1 percent, or no more than about 5 percent, or no more than about 10 percent, or no more than about 15 percent, or no more than about 20 percent, or no more than about 25 percent, or no more than about 30 percent of hard aggregates, based on the total number of graphene sheets and hard aggregates.

In some cases, the hard aggregate particles have a surface area of less than about 100 m²/g, or less than about 75 m²/g, or less than about 50 m²/g, or less than about 25 m²/g. Surface areas can be measured using the methods described above.

The solvent can be one or more liquids. Examples of solvents include one or more of water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF), dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), and mixtures of two or more of the foregoing and mixtures of one or more of the foregoing with other carriers. Solvents can be low- or non-VOC solvents, non-hazardous air pollution solvents, and non-halogenated solvents.

The graphene sheets can be dispersed in the solvent using any suitable method. Graphene sheets in dry (e.g. powder) form can be combined with the solvent. Graphene sheets that are formed as solution/suspension/dispersion form can be used directly, concentrated, subjected to solvent exchange, etc. Examples of dispersing methods include mixing, stirring, grinding, milling, ultrasonication, etc. and can use devices such as ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills, etc.

Dispersion aids such as surfactants can be used to assist dispersion. Examples of surfactants include sulfates such as sodium dodecyl sulfate, ammonium lauryl sulfate, sodium laureth sulfate, alkyltrimethylammonium salts: cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-bromo-5-nitro-1,3-dioxane,

dimethyldioctadecylammonium chloride, cetrimonium bromide, dioctadecyldimethylammonium bromide (DODAB), non-ionic surfactants such as polyoxyethylene glycol alkyl ethers, polyoxypropylene glycol alkyl ethers, glucoside alkyl ethers, polyoxyethylene glycol octylphenol ethers, polyoxyethylene glycol alkylphenol ethers, block copolymers of polyethylene glycol and polypropylene glycol, polyoxyethylene glycol sorbitan alkyl esters, and dodecyldimethylamine oxide, etc. The pH can be adjusted as necessary to aid in dispersion.

Examples of dispersion aids include other particles, including nanoparticles. Examples include particles having a spherical, rod-like, or sheet-like morphology. Examples include graphene oxide and nanotubes (such as carbon nanotubes). Additional solvents can be used as dispersion aids. For example, ethanol can be used to assist the dispersion in water, in some cases at a pH of about 9 to about 10.

The graphene sheets and hard aggregates (which tend to settle to the bottom of the dispersion in some cases) can be separated by any suitable means, including sedimentation, gravity sedimentation, centrifugation, electrophoresis. etc.

A flocculating agent is added to the graphene sheets dispersion after the hard aggregates are removed to form loose aggregates of graphene sheets that can be readily redispersed. Flocculating agents can include ionic materials such as electrolytes, salts, polymers, different solvent(s) acids, bases, additives that can influence the pH or the ionic strength of the dispersion, etc. Examples of flocculating agents are sodium chloride, potassium chloride, cations such as Al, Fe, Ca, Mg, etc. cations, sulfates, citrates, phosphates, alum, aluminum chlorohydrate, aluminum sulfate, calcium oxide, calcium hydroxide, iron(II) sulfate, iron(III) chloride, polyacrylamide, sodium aluminate, sodium silicate, chitosan, gelatin, etc.

The flocculated dispersion can be concentrated using any suitable method, such as sedimentation, gravity sedimentation, centrifugation, filtration, filter press, evaporation. The concentrated materials can have a variety of consistencies and viscosities. The can be, for example, free-flowing, in the form of a paste, dry crumble, etc.

Examples of concentrations can include about 0.5 to about 90 weight percent, or about 0.5 to about 80 weight percent, or about 0.5 to about 70 weight percent, or about 0.5 to about 60 weight percent, or about 0.5 to about 50 weight percent, or about 0.5 to about 40 weight percent, or about 0.5 to about 30 weight percent, or about 0.5 to about 20 weight percent, or about 0.5 to about 15 weight percent, or about 0.5 to about 10 weight percent, or about 0.5 to about 5 weight percent, or about 0.5 to about 3 weight percent, or about 0.5 to about 2 weight percent, or about 0.5 to about 1 weight percent, or about 1 to about 90 weight percent, or about 1 to about 80 weight percent, or about 1 to about 70 weight percent, or about 1 to about 60 weight percent, or about 1 to about 50 weight percent, or about 1 to about 40 weight percent, or about 1 to about 30 weight percent, or about 1 to about 20 weight percent, or about 1 to about 15 weight percent, or about 1 to about 10 weight percent, or about 1 to about 5 weight percent, or about 1 to about 3 weight percent, or about 1 to about 2 weight percent, or about 2 to about 90 weight percent, or about 2 to about 80 weight percent, or about 2 to about 70 weight percent, or about 2 to about 60 weight percent, or about 2 to about 50 weight percent, or about 2 to about 40 weight percent, or about 2 to about 30 weight percent, or about 2 to about 20 weight percent, or about 2 to about 15 weight percent, or about 2 to about 10 weight percent, or about 2 to about 5 weight percent, or about 2 to about 3 weight percent, or about 3 to about 90 weight percent, or about 3 to about 80 weight percent, or about 3 to about 70 weight percent, or about 3 to about 60 weight percent, or about 3 to about 50 weight percent, or about 3 to about 40 weight percent, or about 3 to about 30 weight percent, or about 3 to about 20 weight percent, or about 3 to about 15 weight percent, or about 3 to about 10 weight percent, or about 3 to about 5 weight percent, or about 5 to about 90 weight percent, or about 5 to about 80 weight percent, or about 5 to about 70 weight percent, or about 5 to about 60 weight percent, or about 5 to about 50 weight percent, or about 5 to about 40 weight percent, or about 5 to about 30 weight percent, or about 5 to about 20 weight percent, or about 5 to about 15 weight percent, or about 5 to about 10 weight percent, or about 10 to about 90 weight percent, or about 10 to about 80 weight percent, or about 10 to about 70 weight percent, or about 10 to about 60 weight percent, or about 10 to about 50 weight percent, or about 10 to about 40 weight percent, or about 10 to about 30 weight percent, or about 10 to about 20 weight percent, or about 10 to about 15 weight percent, or about 15 to about 90 weight percent, or about 15 to about 80 weight percent, or about 15 to about 70 weight percent, or about 15 to about 60 weight percent, or about 15 to about 50 weight percent, or about 15 to about 40 weight percent, or about 15 to about 30 weight percent, or about 15 to about 20 weight percent, or about 20 to about 90 weight percent, or about 20 to about 80 weight percent, or about 20 to about 70 weight percent, or about 20 to about 60 weight percent, or about 20 to about 50 weight percent, or about 20 to about 40 weight percent, or about 20 to about 30 weight percent, or about 30 to about 90 weight percent, or about 30 to about 80 weight percent, or about 30 to about 70 weight percent, or about 30 to about 60 weight percent, or about 30 to about 50 weight percent, or about 30 to about 40 weight percent, or about 40 to about 90 weight percent, or about 40 to about 80 weight percent, or about 40 to about 70 weight percent, or about 40 to about 60 weight percent, or about 40 to about 50 weight percent, or about 50 to about 90 weight percent, or about 50 to about 80 weight percent, or about 50 to about 70 weight percent, or about 50 to about 60 weight percent, or about 60 to about 90 weight percent, or about 60 to about 80 weight percent, or about 60 to about 70 weight percent, or about 70 to about 90 weight percent, or about 70 to about 80 weight percent, based on the weight of graphene sheets and solvent.

The flocculated dispersion can be subjected to a solvent exchange procedure. This could be done, for example, if the graphene sheets were formed or more easily dispersed in a first solvent and it was desired to use the hard-aggregate free dispersions in a different solvent.

The flocculated dispersions can be used in many applications. They can be combined with other materials to form composites. They can be added to polymer systems to form composites. Other additives may also be optionally used. For example, they can be added to thermoplastic, thermosetting, and other polymers using any suitable means, including melt processing (using, for example, one or more of single or twin-screw extruders, blenders, kneaders, mixers, Brabender mixers, Banbury mixers, roller mills (such as two-roll mills, three-roll mill), etc.), solution/dispersion processing/blending, via thermosetting lay-ups, etc. The flocculated dispersions can be added to monomers or oligomers that are then in-situ polymerized to form the polymers. The dispersions can be added to a polymer matrix that is then cross-linked, vulcanized, or otherwise cured. The flocculated dispersions can be blended with rubbers and other elastomers in a mixer and the rubber or elastomer blends later crosslinked. The solvent can be removed in whole or in part during the processing. The solvent can include monomers or oligomers that can be part of an in situ polymerization process.

Examples of polymers include polyolefins, such as polyethylene, low density polyethylene (LDPE), linear low density polyethylene (LLDPE), high density polyethylene, ultrahigh molecular weight polyethylene, polypropylene, olefin polymers and copolymers, ethylene/propylene copolymers (EPR), ethylene/propylene/diene monomer copolymers (EPDM); olefin and styrene copolymers; polystyrene (including high impact polystyrene); styrene/butadiene rubbers (SBR); styrene/ethylene/butadiene/styrene copolymers (SEBS); isobutylene/maleic anhydride copolymers; ethylene/acrylic acid copolymers; acrylonitrile/butadiene/styrene copolymers (ABS); styrene/acrylonitrile polymers (SAN); styrene/maleic anhydride copolymers; poly(acrylonitrile); polyethylene/acrylonitrile butadiene styrene (PE/ABS), poly(vinyl pyrrolidone) and poly(vinyl pyrrolidone) copolymers; vinyl acetate/vinyl pyrrolidone copolymers; poly(vinyl acetate); poly(vinyl acetate) copolymers; ethylene/vinyl acetate copolymers (EVA); poly(vinyl alcohols) (PVOH); ethylene/vinyl alcohol copolymers (EVOH); poly(vinyl butyral) (PVB); poly(vinyl formal), polycarbonates (PC); polycarbonate/acrylonitrile butadiene styrene copolymers (PC/ABS); polyamides; polyesters; liquid crystalline polymers (LCPs); poly(lactic acid) (PLA); poly(phenylene oxide) (PPO); PPO-polyamide alloys; polysulphones (PSU); polysulfides; poly(phenylene sulfide); polyetherketone (PEK); polyetheretherketone (PEEK); cross-linked polyetheretherketone (XPEEK); polyimides; polyoxymethylene (POM) homo- and copolymers (also called polyacetals); polyetherimides; polyphenylene (self-reinforced polyphenylene (SRP); polybenimidazole (PBI), aramides (such as Kevlar® and Nomex®); polyureas; alkyds; cellulosic polymers (such as nitrocellulose, ethyl cellulose, ethyl hydroxyethyl cellulose, carboxymethyl cellulose, cellulose acetate, cellulose acetate propionates, and cellulose acetate butyrates); polyethers (such as poly(ethylene oxide), poly(propylene oxide), poly(propylene glycol), oxide/propylene oxide copolymers, etc.); alkyds; acrylic latex polymers; polyester acrylate oligomers and polymers; polyester diol diacrylate polymers; phenolic resins; melamine formaldehyde resins; urea formaldehyde resins; novolacs; poly(vinyl chloride); poly(vinylidene chloride); fluoropolymers (such as polytetrafluoroethylene (PTFE), fluorinated ethylene propylene polymers (FEP), poly(vinyl fluoride), poly(vinylidene fluoride), vinylidene fluoride/hexafluoropropylene copolymers (VF2/HFP), vinylidene fluoride/hexafluoropropylene/tetrafluoroethylene (VF2/HFP/TFE) copolymers, vinylidene fluoride)/vinyl methyl ether/tetrafluoroethylene (VF2/PVME/TFE) copolymers, vinylidene fluoride/hexafluoropropylene/tetrafluoroethylene copolymers (VF2/HPF/TFE), vinylidene fluoride/tetrafluoroethylene/propylene (VF2/TFE/P) copolymers, perfluoroelastomers such as tetrafluoroethylene perfluoroelastomers (FFKM), highly fluorinated elastomers (FEPM), perfluoro(alkyl vinyl ethers), perfluoro(methyl vinyl ether) (PMVE), perfluoro(ethyl vinyl ether) (PEVE), perfluoro(propyl vinyl ether) (PPVE), fluoropolymers having one or more repeat units derived from vinylidene fluoride, hexafluoropropylene, tetrafluoroethylene, chlorotrifluoroethylene (CTFE), perfluoro(alkyl vinyl ethers), etc.); polysiloxanes (e.g., (polydimethylenesiloxane, dimethylsiloxane/vinylmethylsiloxane copolymers, vinyldimethylsiloxane terminated poly(dimethylsiloxane), etc.); polyurethanes (thermoplastic and thermosetting (including crosslinked polyurethanes such as those crosslinked amines, etc.); epoxy polymers (including crosslinked epoxy polymers such as those crosslinked with polysulfones, amines, etc.); acrylate polymers (such as poly(methyl methacrylate), acrylate polymers and copolymers, methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates, etc.), etc.

Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-methylpentamethyleneterephthalamide), etc. The polyamides can be polymers and copolymers (i.e., polyamides having at least two different repeat units) having melting points between about 120 and 255° C. including aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, etc. Examples of these include those sold under the trade names Macromelt by Henkel and Versamid by Cognis.

Examples of acrylate polymers include those made by the polymerization of one or more acrylic acids (including acrylic acid, methacrylic acid, etc.) and their derivatives, such as esters. Examples include methyl acrylate polymers, methyl methacrylate polymers, and methacrylate copolymers. Examples include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers can comprise repeat units derived from other monomers such as olefins (e.g. ethylene, propylene, etc.), vinyl acetates, vinyl alcohols, vinyl pyrrolidones, etc. They can include partially neutralized acrylate polymers and copolymers (such as ionomer resins).

Examples of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT)), etc.

Composites can contain additional components, such as accelerators, antioxidants, antiozonants, carbon black, calcium, clays, curing systems (e.g., peroxides (e.g., dicumyl peroxide), sulfur, initiators, etc.), crosslinkers, lubricants, mold-release agents, fatty acids (stearic acid), zinc oxide, silica, processing aids, blowing aids, adhesion promoters, plasticizers, dyes, pigments, reinforcing agents and fillers (glass fibers, carbon fibers, miners, etc.), heat stabilizers, UV stabilizers, flame retardants, metals, electrically and/or thermally conductive additives, etc.

In some cases, the graphene sheets can be present in the polymer composite in from about 0.001 to about 90 weight percent, or about 0.001 to about 70 weight percent, or about 0.001 to about 50 weight percent, or about 0.001 to about 30 weight percent, or about 0.001 to about 25 weight percent, or about 0.001 to about 20 weight percent, or about 0.001 to about 10 weight percent, or about 0.001 to about 5 weight percent, or about 0.001 to about 3 weight percent, or about 0.001 to about 2 weight percent, or about 0.001 to about 1 weight percent, or about 0.001 to about 0.5 weight percent, or about 0.1 to about 25 weight percent, or about 0.1 to about 20 weight percent, or about 0.1 to about 10 weight percent, or about 0.1 to about 5 weight percent, or about 0.1 to about 3 weight percent, or about 0.1 to about 2 weight percent, or about 0.1 to about 1 weight percent, or about 0.1 to about 0.5 weight percent, or about 0.5 to about 25 weight percent, or about 0.5 to about 20 weight percent, or about 0.5 to about 10 weight percent, or about 0.5 to about 5 weight percent, or about 0.5 to about 3 weight percent, or about 0.5 to about 2 weight percent, or about 0.5 to about 1 weight percent, or about 1 to about 25 weight percent, or about 1 to about 20 weight percent, or about 1 to about 10 weight percent, or about 1 to about 5 weight percent, or about 1 to about 3 weight percent, or about 1 to about 2 weight percent, or about 2 to about 25 weight percent, or about 2 to about 20 weight percent, or about 2 to about 10 weight percent, or about 2 to about 5 weight percent, or about 2 to about 3 weight percent, based on the weight of the polymer and graphene sheets.

The polymer composites can be formed into a wide variety of articles. Articles can be formed from the composite compositions using any suitable method, including spinning, compression molding, extrusion, ram extrusion, injection molding, extrusion, co-extrusion, rotational molding, blow molding, injection blow molding, flexible molding, thermoforming, vacuum forming, casting, solution casting, centrifugal casting, overmolding, reaction injection molding, vacuum assisted resin transfer molding, spinning, printing, spraying, sputtering, coating, roll-to-roll processing, laminating, etc. Thermoset compositions can be formed by mixing resin precursors with dispersions and, optionally, other additives in a mold and curing to form the article.

Examples of articles include molded articles, fibers, filaments, sheets, films, extruded articles, yarns, fabrics, etc. They can include (hot and/or cold) drawn fibers and filaments.

Fibers (also referred to herein as filaments) may take on a variety of forms, including, staple fibers (also referred to as spun fibers), monofilaments, multifilaments, and the like. In one embodiment, the fibers may have number average diameters of about 1 micrometers to about 1.5 mm. They may also have number average diameters of about 15 micrometers to about 1.5 mm.

The fibers may be of any cross-sectional shape. For example, they may have a circular or substantially circular cross-section, or have cross-sections that are, for example, oval, star-shaped, multilobal (including trilobal), square, rectangular, polygonal, irregular, etc. They may also be hollow in their entirety or in part or be foamed. They may be crimped, bent, twisted, woven or the like.

Fibers may be in the form of a multicomponent (such as a bicomponent) composite structure (these are also referred to as conjugate fibers), including multilayered structures comprising two or more concentric and/or excentric layers (including inner core and outer sheath layers), a side-by-side structure, or the like. These can be obtained, for example, extruding two or more polymers from the same spinnerette.

Examples of bicomponent structures include fibers comprising a polyester core and a copolyester sheath, a polyester core and a polyethylene sheath, a polyester core and a polyamide sheath, a polyethylene naphtalate core and a sheath of another polyester, a polyamide core and a copolyamide sheath, a polyamide core and a polyester sheath, a polypropylene core and a polyethylene sheath, and the like.

The fibers may be formed by any suitable method. For example, they may be formed by any suitable spinning process. For example, when spinning, suitable nozzles (such as spinnerettes) may be selected to form monofilament or multifilament fibers.

When melt spinning, a quench zone may be used for the solidification of the filaments. Examples of quench zones include cross-flow, radial, horizontal, water bath, and other cooling systems. A quench delay zone that may be heat or unheated may be used. Temperature control may be done using any suitable medium, such as a liquid (e.g. water), a gas (e.g. air), and/or the like.

Filaments and yarns may be subjected to one or more drawing and/or relaxation operations during and/or subsequent to the spinning process. Drawing and/or relaxation processes may be combined with spinning processes (such as by using a spin draw process), or may be done using separate drawing equipment to pre-spun fibers in form of monofilament or multifilament yarns.

The drawing process may be done, for example, by using different speed single or duo godets or rolls, with heating (hot drawing), without heating (cold drawing), or both. The draw ratio may be controlled by heating and/or annealing during the quench delay zone. Heating may be achieved using heated godets, one or more hot boxes, etc.

Relaxation may be done with heating (hot drawing), without heating (cold drawing), or both.

The spinning speed, spinline tension, spinline temperature, number of drawing stages, draw ratio, relaxation ratio, speed ratios between each relaxation and drawing step, and other parameters may vary. The parameters of the drawing and/or relaxation processes may be selected according to the polymer or polymers used, the polymer structures, processability requirements, and/or desired physical and/or chemical properties of the fibers and/or filaments.

Spinning and/or drawing processes may affect one or more of the degree of crystallization, crystallization rates, crystal structure and size, crystalline orientation, amorphous orientation, and the like. Filament and yarn properties (such as tensile modulus and strength) may vary as a function of spinning and/or drawing processes.

In certain cases it is possible that the functionalized graphene sheets may help to increase orientation and crystallization of the polymer structure during spinning processes.

A spin finish oil may optionally be applied to the filament after quenching but before any drawing and/or relaxation steps. A finish oil may also be optionally applied to fibers before or during subsequent processes such as twisting, weaving, dipping, etc.

The fibers may be electrically conductive, meaning that they may have a conductivity of at least about 10⁻⁶ S/m. In some embodiments of the invention, the fibers preferably have a conductivity of about 10⁻⁶ S/m to about 10⁵ S/m, or more preferably of about 10⁻⁵ S/m to about 10⁵ S/m. In other embodiments of the invention, they have a conductivity of at least about 100 S/m, or at least about 1000 S/m, or at least about 10⁴ S/m, or at least about 10⁵ S/m, or at least about 10⁶ S/m.

The fibers may be formed into fabrics that comprise at least one fiber of the present invention. The fibers may also be formed into yarns that comprise at least one fiber of the present invention. The yarns may be in the form of filament yarns, spun yarns, or the like. The yarns may additionally be formed into cords that comprise at least one yarn of the present invention.

The fibers, yarns, and/or cords may be formed into fabrics. The fabrics may be woven fabrics, non-woven fabrics (including spunbonded, spunlaid, spun laced, etc. fabrics), knit fabrics, and the like and may comprise additional components, including fibers, yarns, and/or cords other than those comprising polymer and graphene. The fibers may also be formed into microfiber fabrics.

Spunbonded (also referred to as spunlaid) non-woven fabrics may be made by depositing spun fibers onto a moving perforated belt. The deposited fibers may subsequently be melt bonded, mechanically interlocked, joined with an adhesive, etc. Examples of uses for non-woven fabrics include, but are not limited to, hygienic fabrics, medical fabrics; cleaning fabrics; filters; cleaning clothes; geotextiles; carpet backings; and the like.

The fibers, yarns, cords, and fabrics of the present invention may have enhanced tensile properties and strengths and tenacities.

The fibers, yarns, cords, and fabrics may be incorporated into larger articles, such as other polymeric and ceramic articles. They may be fully or partially encapsulated by or coated with other materials (such as polymeric materials) or may be wound around or bonded to other articles. They may be part of multilayer or multiply structures, including tubular structures such as pipes and tubes and may be formed such that the composition used herein forms one or more layers including exterior layers, core layers, interior layers, and the like. For example, the fiber may be a multilayered fiber in which the outermost and/or innermost and/or in-between layer comprises the composition used in the present invention.

They may be used in a variety of applications including, but not limited to: textile fibers and yarns; reinforcing fibers, yarns and materials; geotextiles; carpet fibers and yarns; carpet backings; structural and architectural fibers and yarns (such as those used in roofs and membrane roofs); concrete reinforcing materials; composite reinforcing materials; bristles for brushes (such as paint brushes and tooth brushes); fishing lines; ropes; cables; cordage; marine cables, mooring cables; boat rigging lines; hawsers; bow strings; tow lines; climbing ropes and equipment; space tethers; coated fabrics; hygienic fabrics; medical fabrics; cleaning fabrics; clothing and garment fabrics; protective apparel (such as fire fighter protective equipment, astronaut space suits, ballistic vests, helmets, heat and splash protection equipment, etc.); thermal liners; filters and filtration fabrics; flags; sails; awnings; upholstery (including furniture upholstery); carpets and floor coverings; air bags; seat belts; parachutes and parachute lines; kites and kite lines; air balloons (including weather balloons); fire hoses; air hoses; reinforcing agents for materials transport; water sacks for aerial fire fighting aircraft; tenting; tarpaulins; sleeping bags; tapes; belts; netting (including safety nets and anti-erosion nets); racket strings; strapping materials; strips; sheets; packaging; etc.

They can be used in reinforced rubber goods and other articles, such as belts (such as conveyor belts, transmission belts, timing belts, v-belts, power transmission belts, pump belts, antistatic belts, etc.), diaphragms and membrane fabrics (such as those used in diaphragms, air brakes, roofing, and the like), hoses (such as automotive under-hood hoses, high pressure hoses, and the like), air springs, textile architectural components, etc. The articles include manufactured rubber goods. Examples of belts include, but are not limited to, belts for open or closed mining operations, belts for transporting luggage and cargo (as in airports, for example), belts used in factory production, belts used in shopping check-out areas, belts used in construction, belts used in power plant operations, man lifts, etc.

The fibers, yarns, cords, and fabrics may be incorporated in spun over-pressure vessels, pipes and tubes, body armor, vehicle armor, automotive body panels and other components, protective cockpits for automobile and airplane operators, boat hulls, umbilical cables (such as those used in oil and gas exploration and extraction), skis and snowboards, safety glass, etc.

They can be formed into tire cords that can be incorporated into structures such as strips, tapes, fabrics, ply structures, etc. The structures can be twisted, woven, non-woven, or assembled using any suitable method. Tire cords and/or structures may be embedded in rubber to form belts, plies, cap plies, and the like. They may be used as belt plies and body plies and chafer fabrics. Calendering may be used to incorporate the cords and/or structures into the rubber.

Tire cords may be treated with an adhesive prior to being embedded into rubber. Examples of adhesives include RFL (resorcinol formaldehyde latex) dips, cements, isocyanates, epoxies, and the like. Tire cord fabrics may be used in belts, plies, cap plies, single end cords, and the like.

Tire cords and tire cord structures may be used in non-pneumatic tires and pneumatic tires, including radial tires, bias ply tires, tubeless tires, etc. The tires may be used in motorized vehicles, equipment, and accessories such as, but not limited to, automobiles, trucks, motorcycles, mopeds, all terrain vehicles, golf carts, construction equipment, lawn mowers, tractors, harvesters, trailers, wheelchairs, etc. They may be used in non-motorized motorized vehicles, equipment, and accessories such as, but not limited to, bicycles, tricycles, unicycles, wheelchairs, wheel barrows, carts, etc.

The compositions can be used to make inks and coatings. They can be optionally combined with a binder and/or other components. The inks and coatings can be applied to a substrate using any suitable method, including, but not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing, microprinting, pad printing, tampon printing, stencil printing, wire rod coating, drawing, flexographic printing, stamping, xerography, microcontact printing, dip pen nanolithography, laser printing, via pen or similar means, etc. The inks and coatings can be applied in multiple layers.

The inks and coatings can be used for a wide variety of applications, such as passivation of surfaces (such as metal) surfaces, printed electronic devices, RFID devices, EMI shielding, solar cell applications, LED applications, labels, anti-counterfeiting devices, etc.

The compositions can be used to make electrodes, such that those used in energy storage devices, such as batteries, capacitors, supercapacitors, solar energy devices, electrochemical sensors, etc.

The graphene sheets in the compositions can be used as reaction catalysts, or as a carrier for catalysts or other particles. The compositions can be used in applications where high surface area graphene sheets are useful.

The compositions can in some cases be electrically and/or thermally conductive, as can derivatives of the compositions, such as composites, articles, inks and coatings (before and/or after curing/drying), electrodes, etc.

In some cases, the compositions or derivatives of the compositions (e.g. composites, articles, inks and coatings, electrodes, etc.), can have a conductivity of at least about 10⁻⁸ &M. It can have a conductivity of about 10⁻⁶ S/m to about 10⁵ S/m, or of about 10⁻⁵ S/m to about 10⁵ S/m. In other embodiments of the invention, the coating has conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 10⁵ S/m, or at least about 10⁶ S/m.

In some cases, the surface resistivity of the compositions or derivatives of the compositions can be no greater than about 10 megaΩ/square/mil, or no greater than about 1 mega Ω/square/mil, or no greater than about 500 kiloΩ/square/mil, or no greater than about 200 kiloΩ/square/mil, or no greater than about 100 kiloΩ/square/mil, or no greater than about 50 kiloΩ/square/mil, or no greater than about 25 kilo Ω/square/mil, or no greater than about 10 kiloΩ/square/mil, or no greater than about 5 kilo Ω/square/mil, or no greater than about 1000 Ω/square/mil, or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

In some cases, the compositions or derivates of the compositions can have a thermal conductivity of about 0.1 to about 50 W/m·K, or of about 0.5 to about 30 W/m·K, or of about 0.1 to about 0.5 W/m·K, or of about 0.1 to about 1 W/m·K, or of about 0.1 to about 5 W/m·K, or of about 0.5 to about 2 W/m·K, or of about 1 to about 5 W/m·K, or of about 0.1 to about 0.5 W/m·K, or of about 0.1 to about 50 W/m·K, or of about 1 to about 30 W/m·K, or of about 1 to about 20 W/m·K, or of about 1 to about 10 W/m·K, or of about 1 to about 5 W/m·K, or of about 2 to about 25 W/m·K, or of about 5 to about 25 W/m·K, or of at least about 0.7 W/m·K, or of at least 1 W/m·K, or of at least 1.5 W/m·K, or of at least 3 W/m·K, or of at least 5 W/m·K, or of at least 7 W/m·K, or of at least 10 W/m·K, or of at least 15 W/m·K.

### EXAMPLES

### Example 1

### Preparation of Dispersions of Graphene Sheets

Graphene is oxidized to make graphite oxide. The graphite oxide is thermally exfoliated at about 1100° C. to make graphene sheets. The graphene sheets and sodium dodecyl sulfate (SDS) are added to deionized water, and the resulting mixture is sonicated. The resulting dispersion is centrifuged and the supernatant (which contains the graphene sheets) is removed using a peristaltic pump. Care is taken to prevent the sediment from being removed or disturbed.

A KCl solution in deionized water (1 M) is added to the collected supernatant in bottles that are shaken thoroughly in order to flocculate the graphene sheets. The flocculated dispersion is centrifuged and the supernatant is removed. The sediment contains the flocculated graphene sheets and is subjected to a solvent exchange operation, first exchanging the water with isopropanol, and then Electron (supplied by Ecolink). The composition containing graphene sheets and Electron is concentrated to form a paste of about 10 wt % graphene sheets.

### Comparative Examples 2-4

### Preparation of Dispersions of Graphene Sheets Containing Hard Aggregates

Graphene is oxidized to make graphite oxide. The graphite oxide is thermally exfoliated at about 1100° C. to make graphene sheets. A 1.75 weight percent mixture of graphene sheets is made in Electron (supplied by Ecolink). The dispersion is milled in a ball mill to achieve a particle size d90 of 1 micrometers (as measured by laser light scattering). The resulting dispersion is then sonicated for about 20 hours and concentrated by vacuum filtration to make a paste that is melt compounded into PET.

### Preparation of Composites and Fibers

The pastes of Example 1 and Comparative Examples 2-4 are melt compounded with PET in a twin screw extruder at the concentrations given in Table 1, pelletized, and solid-state polymerized to an intrinsic viscosity of about 1. The resulting PET pellets containing graphene sheets are spun into fibers. Comparative Example 1 is PET pellets that do not contain graphene sheets.

The pellets are dried under 30 psi vacuum at 120° C. for at least 20 h prior to spinning. Spinning is done using a Thermo Fisher Haake twin screw extruder with a length to diameter ratio of 40 and a spinneret hole diameter of 2 mm. The pellets are flood fed to the extruder with a continuous nitrogen purge. The extruder has 10 zones with temperature control that are set to temperatures of between about 280 and 325° C. The rotational velocity of the screws is about 5 to 12 rpm. Pressure at the exit of the extruder varies between 9 to 11 bars. Throughput is measured by collecting the fibers extruded in one minute and weighing them.

Fibers exiting the extruder are immediately passed through a water bath which is filled with tap water (not temperature controlled). The water level is about 1 to 10 cm below the spinneret. After passing though the water bath, the fibers are passed through a zone with radial nitrogen flow to remove most of the water and then collected using a winder that is set to a velocity of between about 23 and 75 rpm.

### Results

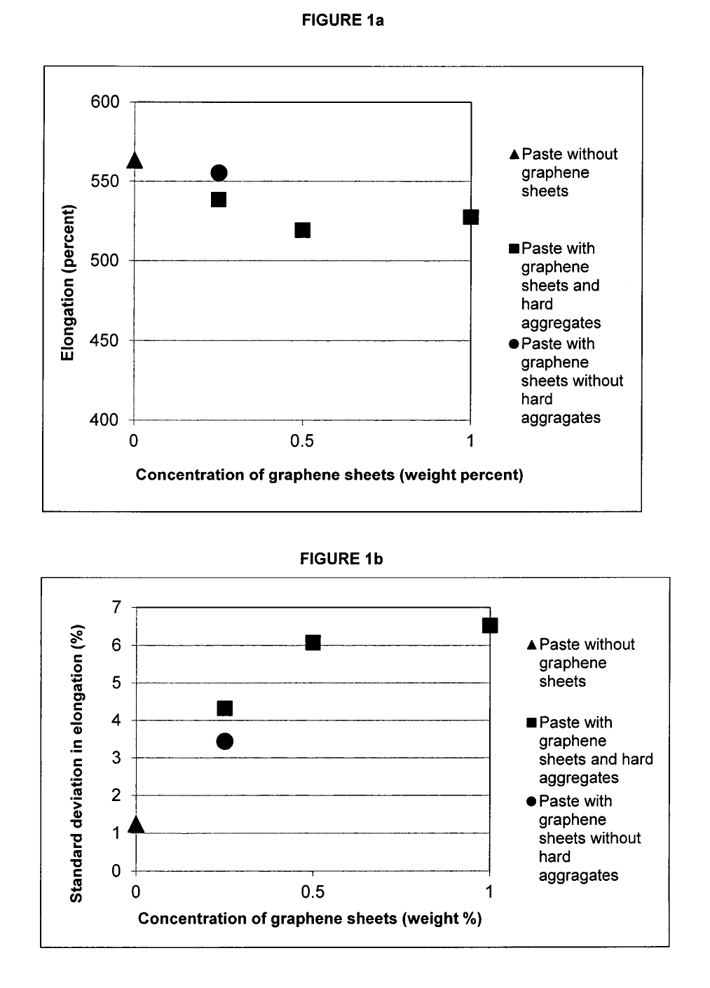

FIGS. 1a and 1b and Table 1 show the elongation at failure and its standard deviation for the spun fibers at different concentrations of graphene sheets. Tensile testing of the samples is done using an Instron tester with a 50 N load cell and fiber clamps. The strain rate is typically 50 mm/min. The diameters of the samples are measured under optical microscopy after the Instron testing and the initial diameters are back calculated assuming that the volume is conserved. Five tensile tests are done for each composition and average values are reported.

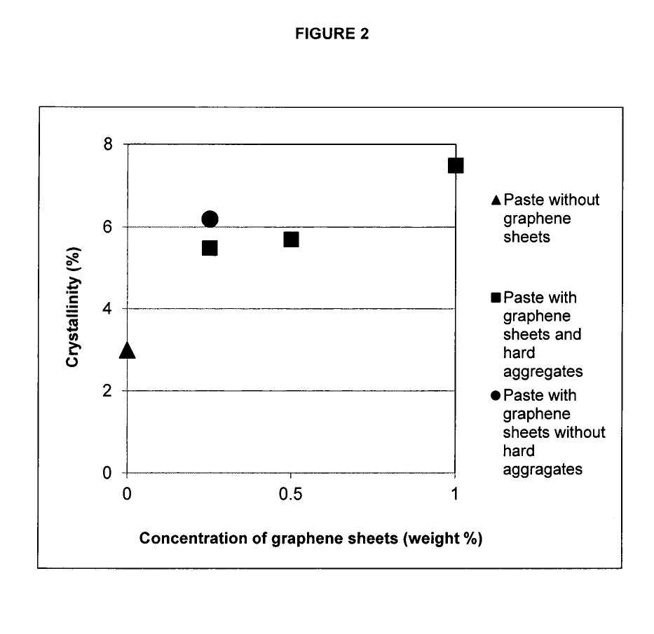

FIG. 2 and Table 1 show the effect of graphene sheets on the crystallinity of the PET in the fibers. Crystallinity is measured using the differences in the crystallization and melting energies of the samples and then scaling it with that of 100 percent crystalline PET. The crystallization and melting energies are measured using differential scanning calorimetry using a Netzsch 449 C Jupiter thermal analyzer. As spun fibers were cut about 3-5 mg samples that were heated at a constant rate of 20° C./min under a nitrogen atmosphere and the heat flow per mass was recorded for each sample.

TABLE 1

| | | Comp. | Comp. | Comp. | Comp. |
|---|---|---|---|---|---|
| | Example 1 | Ex. 1 | Ex. 2 | Ex. 3 | Ex. 4 |
| Graphene sheets | 0.25 | 0 | 0.25 | 0.5 | 1 |
| conc. (weight %) | | | | | |
| Elongation (%) | 563 | 555 | 539 | 519 | 527 |
| (average) | | | | | |
| Elongation (%) | 7 | 19 | 23 | 32 | 34 |
| (standard deviation) | | | | | |
| Crystallinity (%) | 5.0 | 13.6 | 16.6 | 22.5 | 24.6 |

1. A method of making a composition comprising graphene sheets and at least one solvent, comprising dispersing a mixture of graphene sheets and graphite particles in a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, and flocculating the dispersion of graphene sheets.

2. The method of claim 1, further comprising the step of concentrating the flocculated dispersion of graphene sheets.

3. The method of claim 1, wherein the graphene sheets have a surface area of at least about 200 m²/g.

4. The method of claim 1, wherein the graphite sheets have a surface area of at least about 300 m²/g.

5. The method of claim 1, wherein the dispersion of graphene sheets contains no more than about 20% of particles having more than about 10 layers.

6. The method of claim 1, wherein the dispersion of graphene sheets contains no more than about 10% of particles having more than about 10 layers.

7. The method of claim 1, wherein the dispersion of graphene sheets contains no more than about 10% of particles having more than about 5 layers.

8. The method of claim 1, wherein the dispersion of graphene sheets contains no more than about 5% of particles having more than about 5 layers

9. A method of making a polymer composite material, comprising dispersing a mixture of graphene sheets and graphite particles into a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, separating the graphene sheets and the graphite particles to obtain a dispersion of graphene sheets that contains no more than about 25% of particles having more than about 50 layers, based on the total number of graphite particles and graphene sheets; flocculating the dispersion of graphene sheets; and adding the flocculated dispersion to a polymer matrix.

10. The method of claim 9, wherein the flocculated dispersion is concentrated before it is added to the polymer matrix.

11. The method of claim 9, wherein the polymer matrix comprises one or more polymers selected from the groups consisting of polyesters, polyamides, polyethylenes, rayons, and aramids.

12. The method of claim 9, wherein the graphene sheets have a surface area of at least about 200 m²/g.

13. The method of claim 9, wherein the graphene sheets have a surface area of at least about 300 m²/g.

14. The method of claim 9, wherein the dispersion of graphene sheets contains no more than about 20% of particles having more than about 10 layers.

15. The method of claim 9, wherein the dispersion of graphene sheets contains no more than about 10% of particles having more than about 5 layers

16. A method of making a polymeric article, comprising forming a polymer composite material by dispersing a mixture of graphene sheets and graphite particles into a solvent, wherein the graphite particles have more than about 50 layers, separating the graphene sheets and the graphite particles to obtain a dispersion of graphene sheets that contains no more than 25% of graphite particles having more than about 50 layers, based on the total number of graphite particles and graphene sheets, separating the graphene sheets and the graphite particles to obtain a dispersion of graphene sheets that contains no more than about 25% of particles having more than about 50 layers, based on the total number of graphite particles and graphene sheets; flocculating the dispersion of graphene sheets; adding the flocculated dispersion to a polymer matrix to form the polymer composite material; and forming the polymer composite material into an article.

17. The method of claim 16, wherein the polymer matrix comprises one or more polymers selected from the groups consisting of polyesters, polyamides, polyethylenes, rayons, and aramids.

18. The method of claim 16, wherein the article is a molded article.

19. The method of claim 16, wherein the article is formed by spinning.

20. The method of claim 16, wherein the article is a at least one fiber.

21. The method of claim 16, wherein the dispersion of graphene sheets contains no more than about 10% of particles having more than about 5 layers
